(19) United States
(12) Patent Application Publication
(10) Pub. No.: US 2005/0200696 A1
(43) Pub. Date: Sep. 15, 2005

(54) Display device mountable in a vehicle

(75) Inventor: George C. Schedivy, Aquebogue, NY (US)

Correspondence Address: F. CHAU & ASSOCIATES, LLC, 130 WOODBURY ROAD, WOODBURY, NY, 11797, US

(73) Assignee: Audiovox Corporation

(21) Appl. No.: 10/796,377

(22) Filed: Mar. 9, 2004

(51) Int. Cl. H04N 7/18

(52) U.S. Cl. 348/61

(57) ABSTRACT

A video display device capable of being mounted in an interior portion of a vehicle using at least one strap. The at least one strap is capable of fitting around a visor in the vehicle for mounting the video display device to the visor. The video display device can display an entertainment program and navigation information.

### BACKGROUND OF THE INVENTION

1. Technical Field

The present disclosure relates to a display device, and more particularly to a display device, such as a liquid crystal display (LCD) mountable in a vehicle.

2. Discussion of the Related Art

Electronic devices for navigation and entertainment have become popular in vehicles. For example, devices incorporating global positioning system (GPS) technology have been installed in vehicles to assist drivers in finding their destinations. Also, video entertainment devices, such as video display devices, video cassette players (VCPs) and digital video disc (DVD) players have been provided in vehicles to entertain passengers while traveling.

A known navigation or video entertainment system may be permanently mounted in a vehicle. However, it is also desirable to have a navigation and/or video system that can be securely mounted in a vehicle and easily removed for use in another vehicle.

In addition, for safety reasons, known video entertainment systems are mounted for viewing by passengers in rear seats and do not provide video entertainment for the driver or passengers in the front seats. However, it is desirable to have a video system capable of entertaining a driver and/or front seat passenger when the vehicle is not in motion.

Accordingly, a need exists for a portable GPS and video system capable of being mounted in an interior of a vehicle, including the front seat area of a desired vehicle.

### SUMMARY OF THE INVENTION

A video display device, in accordance with an embodiment of the present invention, comprises a body portion, a screen positioned on the body portion, and at least one strap connected to the body portion for mounting the video display device in an interior portion of a vehicle.

The at least one strap may be capable of fitting around a visor in the vehicle for mounting the video display device to the visor. The at least one strap may be capable of fitting around a portion of a seat in the vehicle for mounting the video display device to the seat.

The at least one strap may pass through an interior portion of the video display device via at least one hole formed in a wall of the video display device. The at least one strap may be secured to a wall of the video display device. The at least one strap may pass through a groove positioned between a front wall and a back wall of the video display device or a groove positioned on a wall of the video display device. The at least one strap may be a closed elastic loop or include two free ends capable of being fastened together to form a closed loop. A length of the at least one strap may be adjustable.

The video display device may be one of a liquid crystal display device, an organic electro-luminescent display device, a cathode-ray tube device and a gas plasma device. The video display device may include a navigation system, wherein the video display device displays navigation information from the navigation system on the screen. The video display device may also be coupled to a navigation system and display navigation information from the navigation system on the screen.

The video display device may be coupled to a media player for displaying a video program from the media player. The video display device may display the video program only when the vehicle is stationary and/or only when a parking brake of the vehicle is engaged. The video display device may further include a device port, wherein the media player and/or a navigation device is coupled to the video display device through the device port. The media player may be one of a portable media player or a media player mounted in the vehicle. The video display device may further include a connector for connecting the video display device to a wiring harness of the vehicle, wherein the video display device is coupled to at least one of a vehicle navigation system, a vehicle media player, a vehicle power supply and a parking brake indicator signal via the connector and the wiring harness.

Another video display device, in accordance with an embodiment of the present invention, comprises a screen, wherein the video display device is capable displaying vehicle navigation information and a video entertainment program on the screen, and the video display device is capable of being mounted to a visor in a vehicle.

The video display device may further comprise at least one strap connected to the video display device, wherein the at least one strap is capable of fitting around the visor. The video display device may be one of a liquid crystal display device, an organic electro-luminescent display device, a cathode-ray tube device and a gas plasma device. The video display device may display the video entertainment program only when the vehicle is stationary and/or only when a parking brake of the vehicle is engaged. The video display device may receive at least one of the vehicle navigation information and the video entertainment program from at least one external device electrically connected to the video display device.

The video display device may be houseable in a support structure including at least one strap connected to the support structure, the at least one strap being capable of fitting around the visor. The support structure may further include a membrane for holding the video display device in the support structure. The membrane may include a hole through which a screen of the video display device is viewed.

A structure for supporting a video display device, in accordance with an embodiment of the present invention, includes a body portion, at least one strap connected to the body portion for mounting the structure in an interior portion of a vehicle, and a membrane connected to the body portion for holding the video display device in the structure.

The at least one strap may be capable of fitting around a visor in the vehicle for mounting the structure to the visor and/or around a portion of a seat in the vehicle for mounting the structure to the seat. The at least one strap may pass through an interior portion of the body portion via at least one hole formed in the body portion. The at least one strap may be secured to a side of the body portion. The at least one strap may be a closed elastic loop or include two free ends capable of being fastened together to form a closed loop. A length of the at least one strap may be adjustable.

The membrane may surround a substantial portion of the display device. The membrane may include a flap capable of being opened to provide an opening through which the video display device is placed in the structure, wherein the flap is capable of being fastened to and unfastened from the body portion. The flap may wrap around part of the body portion.

The membrane may include at least one hole through which a control button of the display device is accessed and/or at least one hole through which a port of the display device is accessed. The membrane may also include a hole through which a screen of the video display device is viewed. The membrane may also include a hole for exposing a speaker, an infrared transmitter and/or an infrared receiver of the video display device. The membrane may be bendable and transparent.

### BRIEF DESCRIPTION OF THE DRAWINGS

Preferred embodiments of the invention can be understood in more detail from the following descriptions taken in conjunction with the accompanying drawings in which:

FIG. 1 shows front perspective view of a display device attached to a sun visor, according to an embodiment of the present invention;

FIG. 2 shows a rear perspective view of a display device attached to a sun visor, according to an embodiment of the present invention;

FIGS. 3A-3D show different strap configurations, according to embodiments of the present invention;

FIG. 4 shows a front perspective view of a display device, according to an embodiment of the present invention;

FIG. 5A shows a front view of a support structure capable of supporting a display device and attaching to a sun visor, according to an embodiment of the present invention;

FIG. 5B shows a rear view of the support structure of FIG. 5A;

FIG. 5C shows a side view of the support structure of FIG. 5A;

FIG. 5D shows a front perspective view of the support structure of FIG. 5A; and

FIG. 5E shows a front perspective view of a display device positioned in the support structure of FIG. 5A.

### DETAILED DESCRIPTION OF THE PREFERRED EMBODIMENTS

Preferred embodiments of the present invention will be described below in more detail with reference to the accompanying drawings. This invention may, however, be embodied in different forms and should not be construed as limited to the embodiments set forth herein. Rather, these embodiments are provided so that this disclosure will be thorough and complete, and will fully convey the scope of the invention to those skilled in the art.

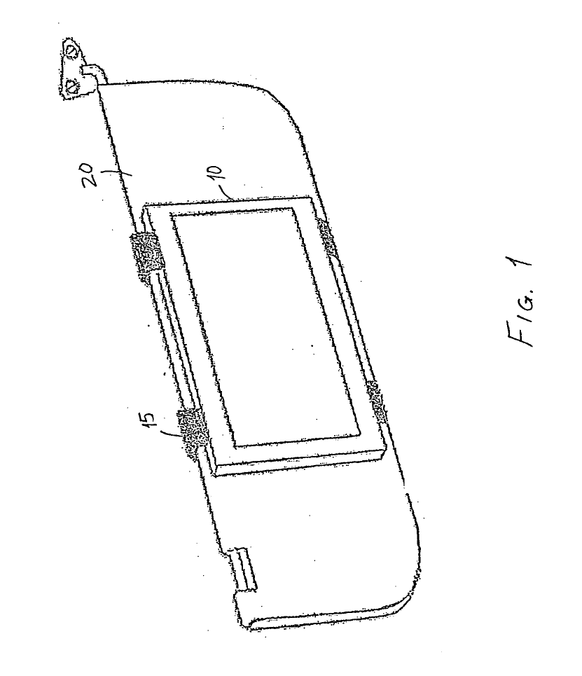

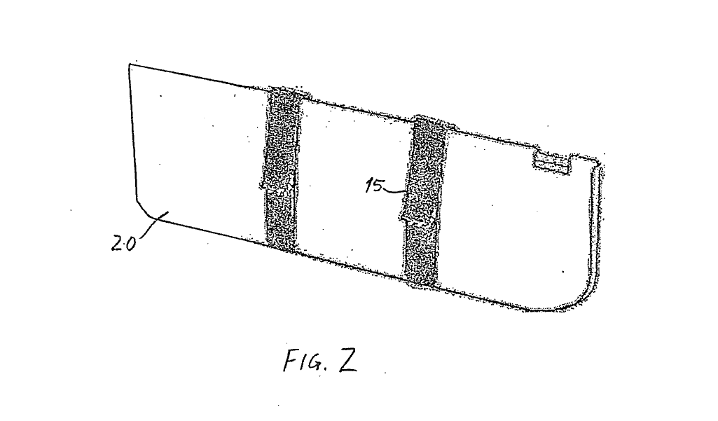

Referring to FIG. 1, a display device 10 is attached to a sun visor 20 in a vehicle. The display device 10 includes a liquid crystal display (LCD). Alternatively, the display device 10 may be a cathode ray tube (CRT), organic electro-luminescent display (OELD) or gas plasma type display device. As shown in FIGS. 1 and 2, the display device 10 is mounted to the visor 20 with straps 15. The straps 15 are wrapped around the visor 20 and are fastened by Velcro strips attached to both ends of each strap. Other fastening devices may be used, such as snaps, clips and the like. The straps 15 may be adjustable to fit around visors of different sizes. The straps 15 may also adjust to fit around a portion of a seat of a vehicle (not shown), such as a headrest or seat body, to mount display device 10 to the seat. Strap adjustment may be made with buckles (not shown), for example. As an alternative, each strap 15 may be a closed elastic loop that stretches and fits tightly around the visor 20. The straps 15 may be made from canvas, rubber, polyester, leather, plastic or the like.

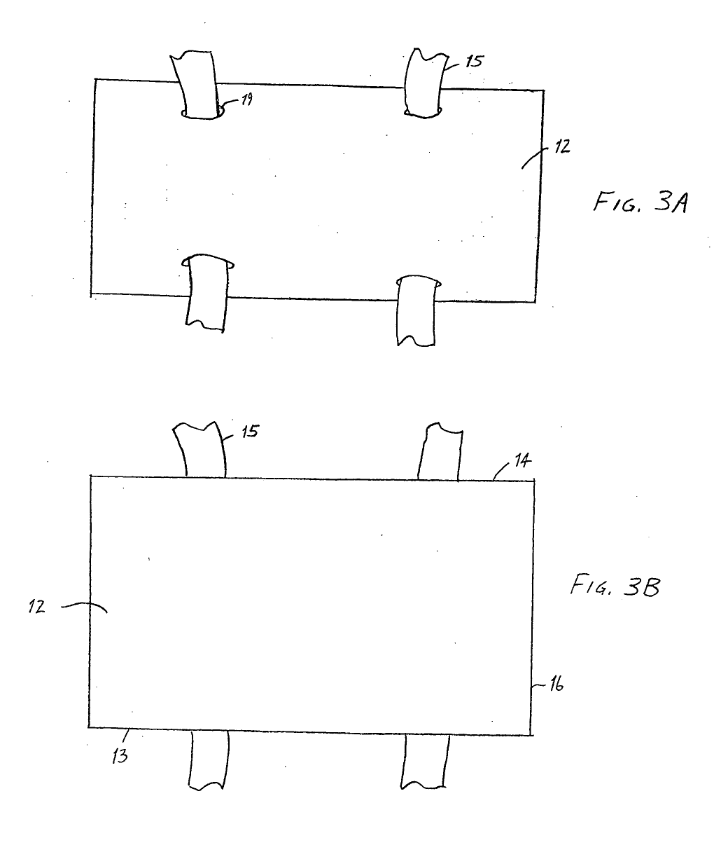

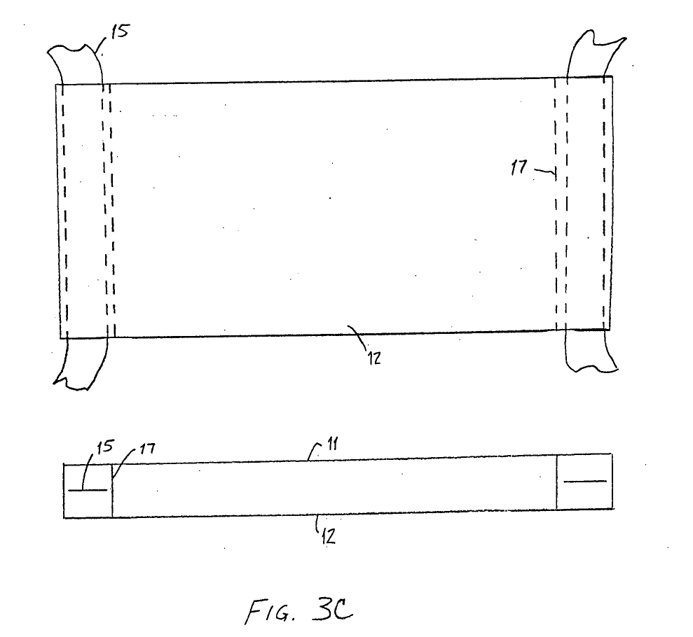

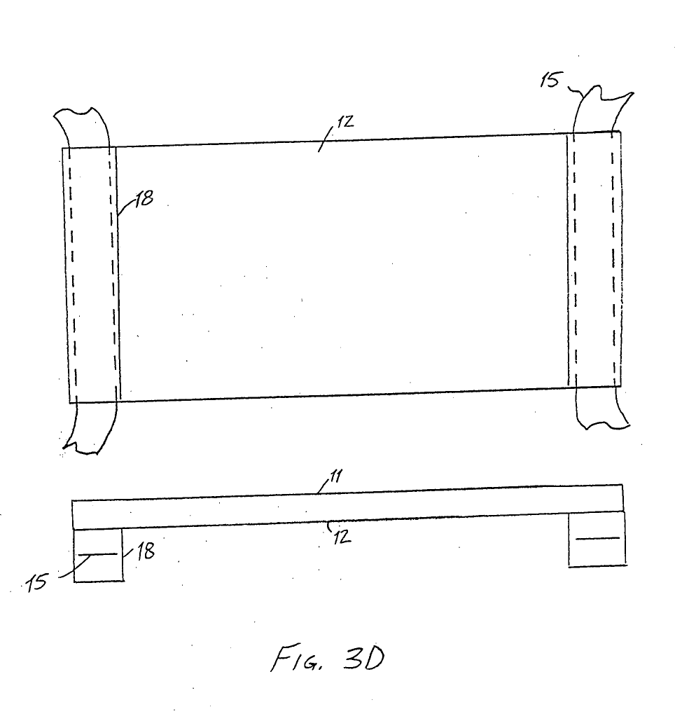

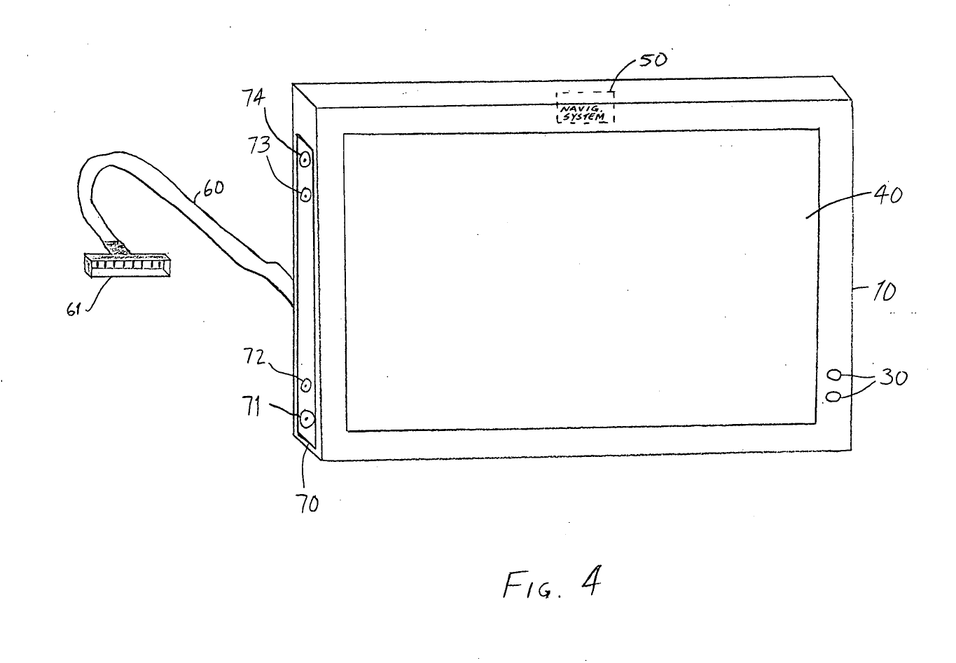

As shown in FIG. 3A, the straps 15 may run through the back of the display device 10 through holes 19 in the back wall 12 of the display device 10. Holes for receiving the straps 15 may be formed in other walls of the display device 10, such as bottom and top walls 13, 14. As an alternative, as shown in FIG. 3B, the straps 15 may be secured to a portion of display device 10 (e.g., wall of the display device 10, such as front, back, bottom, top or side walls 11, 12, 13, 14 or 16) with a fastener, such as an adhesive, rivets, screws or other fastener known to those of skill in the art. As shown in FIG. 3C, the straps 15 may run through grooves 17 positioned between front and back walls 11, 12 of the display device 10. Alternatively, as shown in FIG. 3D, grooves 18 are positioned on the back wall 12. As shown in FIGS. 3C and 3D, the grooves 17, 18 are preferably open only at top and bottom ends and closed around front, back and side portions to prevent the straps 15 from becoming dislodged from the display device 10. The straps 15 may run from the display device 10 in vertical, horizontal or diagonal directions depending on the configuration of the object to which the display device 10 is to be mounted.

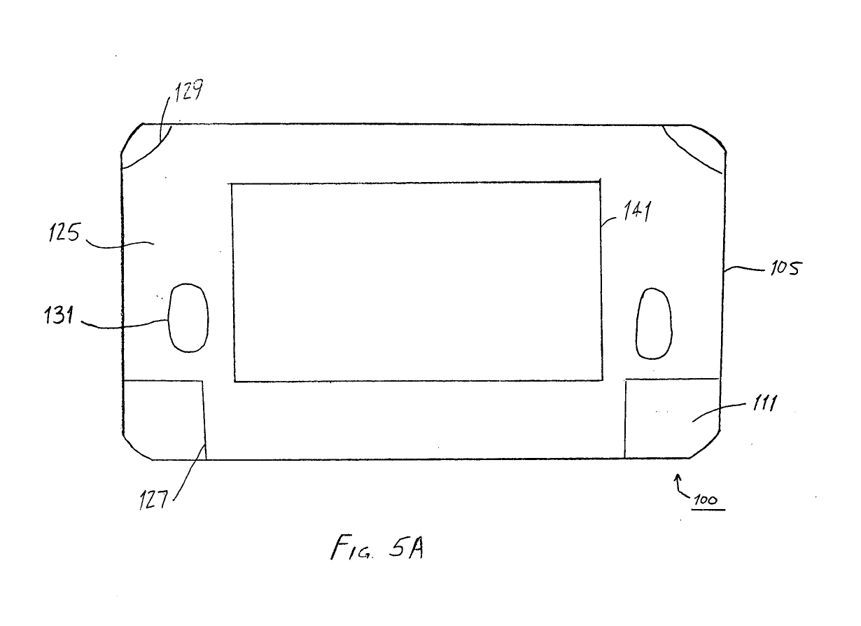

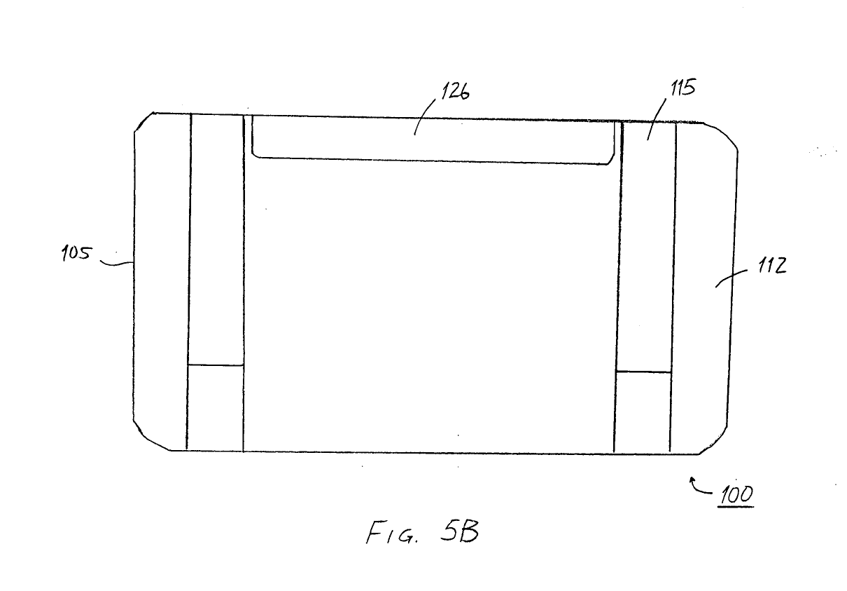

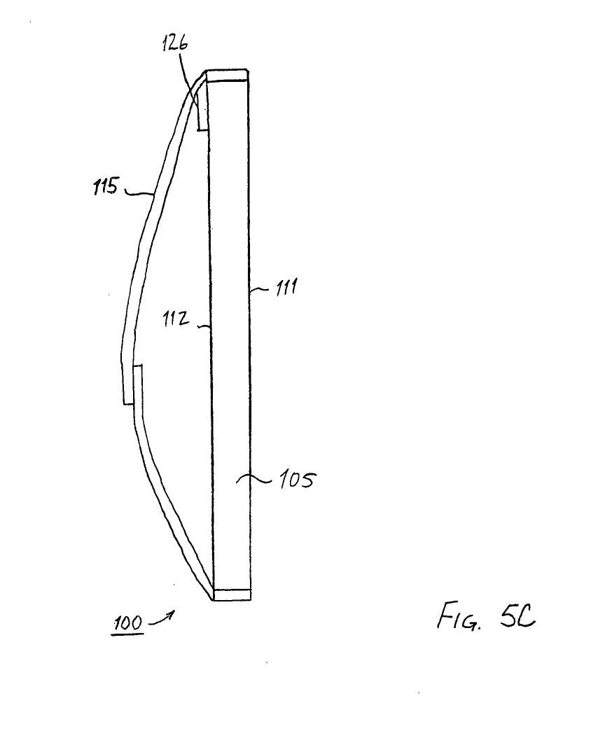

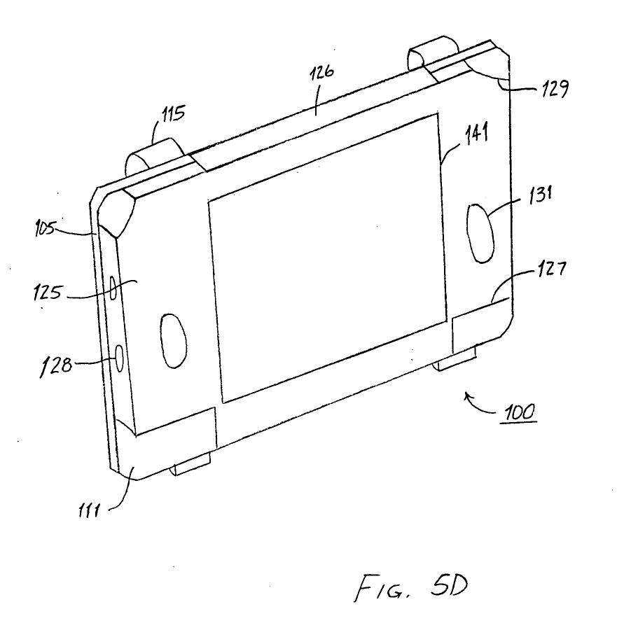

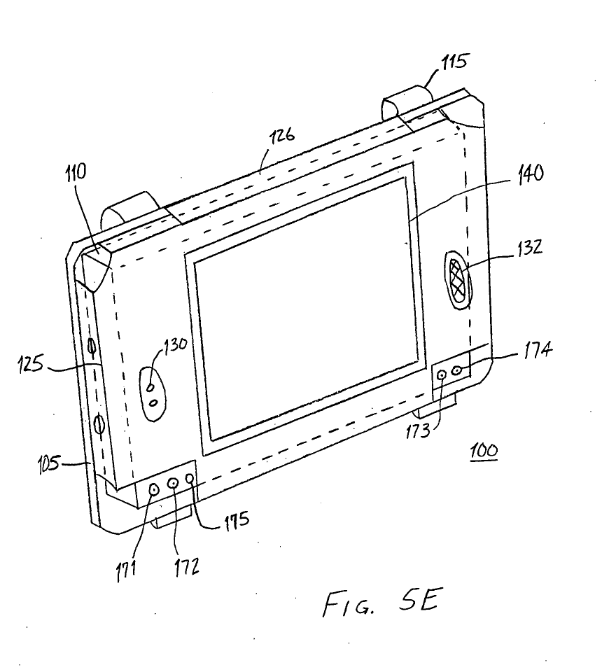

Referring to FIG. 4, the display device 10 includes a screen 40. The screen 40 is preferably an LCD screen. Alternatively, the screen 40 may be a CRT, OELD or gas plasma type screen. The display device 10 displays navigation information on the screen 40 for a driver while the vehicle is in motion. Navigation information includes maps, routes, distance to a destination, current position and the like associated with known vehicle navigation or GPS systems. As shown in FIG. 4, the display device 10 includes a navigation system 50 built into the display device 10, including a transmitter and receiver or a transceiver for transmitting and receiving signals (e.g., via satellite or base stations) to track the position of the vehicle in which the display device 10 is mounted. Alternatively, the display device 10 may work in conjunction with a pre-existing navigation system in a vehicle and connect to the pre-existing system via a wire 60 running from the display device 10. The wire 60 connects to the vehicle, through, for example, a wiring harness accessible in the vehicle passenger area. The wire 60 connects to the wiring harness using a connector 61 including, for example, a pin array. The display device 10 may also work in conjunction with a portable navigation system or device and connect to the portable navigation device through a device port or jack 74 positioned on an input/output port panel 70 on the display device 10. The input/output ports may be positioned on various portions of the display device, such as on the front and side walls 11, 16 thereof. As shown in FIG. 5E, the display device 110 includes input/output ports 171, 172, 173, 174 on a front wall thereof.

The display device 10 is capable of displaying video programs from a media player, such as a VCP, a DVD player, a video compact disc (VCD) player, an MP3 player or similar device capable of downloading and playing computerized video files, or the like. The media player connects to the display device via an auxiliary device port or jack 71 positioned on the input/output port panel 70 on the display device 10. The media player may be portable, such as a portable DVD player or may be mounted in a part of the vehicle, such as an overhead console.

The display device 10 will not play video from the media player while the vehicle is in motion and will only play video when the parking brake is engaged. In order to achieve this result, a microcomputer (not shown) in the display device 10 is electrically connected to a logic output that is in a high state when the parking brake is engaged and in a low state when the parking brake is not set. The logic output can be supplied through the wire 60 connected to a wiring harness in the vehicle. The wiring harness is coupled to circuitry for detecting and outputting signals based on the orientation of the parking brake (e.g., the same circuitry connected to the parking brake indicator light). The display device 10 may utilize the connector 61 on the wire 60 that plugs into the vehicle wiring harness to receive the logic output. The connector 61 may also be used in conjunction with the wiring harness to couple the display device 10 to a vehicle navigation system, to vehicle media players and/or to a vehicle power supply. As an alternative to a connection to a wiring harness for power, the display device may be battery powered or receive power via a port 72 connected to a power port in the vehicle, such as cigarette lighter.

If the logic signal received by the microcomputer is high (i.e., the parking brake is engaged), the microcomputer will generate an image display signal that is processed by a display circuit for displaying the auxiliary video image. However, if the logic signal received by the microcomputer is low (i.e., the parking brake is not engaged), the microcomputer will not generate an image display signal, thereby preventing display of the auxiliary video image. It is to be understood that circuitry for displaying navigation information would not be linked to the microcomputer for receiving signals based on the orientation of the parking brake.

Other configurations known to those of skill in the art for producing signals in connection with whether a vehicle is being driven may be employed. For example, a motion sensor, such as an accelerometer may be employed to send out a signal to the microcomputer when the vehicle is in motion. In another example, a switch linked to the brake mechanism closes when the parking brake is set and produces a logic high signal for receipt by the microcomputer.

The display device 10 includes control buttons 30 positioned thereon for controlling display functions as power, volume, contrast, brightness, mode selection (e.g. navigation or auxiliary video), and the like. Control buttons 30 may also be positioned on the display device 10 for controlling functions related to a GPS display, such as zoom, scrolling and menu controls. Like the input/output ports, the control buttons 30 may be positioned on various portions of the display device, such as in multiple positions on the front and side walls 11, 16 thereof. As shown in FIG. 5E, the display device 110 includes control buttons 130 on opposite sides of a front wall of the display device 110.

The display device 10 includes a headphone port 73 so that audio corresponding to a video display can be sent to headphones. In addition, the display device 10 may include a speaker (not shown) for playing audio.

FIGS. 5A-5E show a support structure 100 capable of supporting a display device 110 and attaching to a sun visor in a vehicle with straps 115. The support structure 100 includes a body portion 105 formed of semi-rigid material including one or more of plastic, rubber, canvas, polyester, cardboard, foam or the like. The body portion 105 has a small thickness relative to the length and width of the body portion 105. For example, the body portion 105 has a rectangular shape similar to that of a sun visor in a vehicle, with a length of about 8 inches to about 15 inches, a width of about 4 inches to about 7 inches and a thickness of about 0.25 inches to about 1 inch. The body portion 105 has a front side 111 and a back side 112.

Like the straps 15, the straps 115 are wrapped around a visor and fastened by Velcro strips attached to both ends of each strap. As described above, other fastening devices may be used, and the straps 115 may be adjustable. Like the straps 15, the straps 115 may adjust or be configured to fit around a portion of a seat of a vehicle (not shown), such as a headrest or seat body. Further, the straps 115 may run from the support structure 100 (i.e., the body portion 105) in the vertical, horizontal or diagonal direction depending on the configuration of the object to which the support structure 100 is to be mounted. Each strap 115 may also be a closed elastic loop that stretches and fits tightly around a portion of the vehicle to which the support structure 100 is mounted.

The straps 115 may be secured to the body portion 105 of the support structure 100, for example to a back side 112 of the body portion 105, by sewing the straps 115 thereto, or by using a fastener, such as an adhesive, rivets, screws or other fastener known to one of ordinary skill in the art. Alternatively, the straps 115 may run through holes (not shown) in the back side 112 of the body portion 105 similar to the holes 19 described in connection with FIG. 3A. The body portion 105 may include padding between front and back sides 111 and 112 of the body portion 105 to prevent damage to a display device 110 resting thereon.

The support structure 100 includes a membrane 125, which surrounds a substantial portion of the display device 110 to hold the display device 110 in place against the body portion 105 and prevent the display device 110 from falling from the support structure 100. The membrane 125 is fastened to the support structure 100 at various points on the front side 111 of the body portion 105. Like the straps 115, the membrane 125 is fastened to the body portion 105 via stitching, but other fastening means also may be used. The membrane 125 includes a flap 126 which wraps around a top portion of the body portion 105 and adheres to the back side 112 of the body portion 105. The flap 126 adheres to the back side 112 with a Velcro strip, but may also be fastened thereto with other fastening means capable of being opened and closed, such as snaps, buckles, magnets, clips, buttons, zippers or the like. The flap 126 is opened to provide an opening through which the display device 110 can be inserted between the body portion 105 and the membrane 125. The flap 126 may be positioned to wrap around alternate portions of the body portion 105, such as around side and bottom portions the body portion 105.

The membrane 125 also includes holes 127, 128, 129 and 131 through which controls 130, a speaker 132, ports 171-174, an infrared (IR) transmitter or receiver 175 and/or connecting devices of the display device 110 may be accessed without removing the display device 110 from the support structure 100. The membrane 125 also includes a hole 141 acting as a window through which a screen 140 of the display device 110 can be viewed. The display device 110 is an LCD, and, alternatively, may be a cathode ray tube (CRT), organic electro-luminescent display (OELD) or gas plasma type display device.

The membrane 125 is formed from a thin and bendable material such as plastic, rubber, canvas, polyester, elastic or the like and may have a continuous or mesh structure. The flexibility of the membrane 125 allows display devices of different sizes and thicknesses to be inserted in the support structure 100. Also, the membrane and body portion combination 125, 105 provides a light and thin support structure that is not too bulky to mount on a visor or a headrest, for example. When a display device is not inserted in the support structure 100, the membrane 125 can remain flat against the body portion 105.

The membrane 125 may be clear so that the majority of display device 110 can be seen while in the support structure 100. Alternatively, the membrane 125 can be translucent or opaque.

As shown in FIG. 5E, a display device 110 inserted into the support structure 100 is similar to the display device 10 described in connection with FIG. 4. For example, the display device 110 includes the same or similar components as the display device 10, such as input/output ports 171-174 and control buttons 130. The display device 110 includes a speaker 132 and an IR transmitter or receiver 175. An IR receiver, for example, may be used for receiving IR signals from a wireless remote control. Although not shown in FIG. 5E, like the display device 10, the display device 110 can also include a navigation system and a wire and connecting device for connecting to a vehicle's wire harness.

The display device 110 functions in the same or a similar manner to the display device 10, in that the display device 110 displays navigation information when the vehicle is in motion and video entertainment programs only when the vehicle is stopped and/or the parking brake is engaged. Further, like the display device 10, the display device 110 may be equipped to receive navigation information and video entertainment programs from in-vehicle or portable sources.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. A video display device, comprising:
a body portion;
a screen positioned on the body portion; and
at least one strap connected to the body portion for mounting the video display device in an interior portion of a vehicle.

2. The video display device as recited in claim 1, wherein the at least one strap is capable of fitting around a visor in the vehicle for mounting the video display device to the visor.

3. The video display device as recited in claim 1, wherein the at least one strap is capable of fitting around a portion of a seat in the vehicle for mounting the video display device to the seat.

4. The video display device as recited in claim 1, wherein the at least one strap passes through an interior portion of the video display device.

5. The video display device as recited in claim 4, wherein the at least one strap passes through the interior portion of the video display device via at least one hole formed in a wall of the video display device.

6. The video display device as recited in claim 1, wherein the at least one strap is secured to a wall of the video display device.

7. The video display device as recited in claim 1, wherein the at least one strap passes through a groove positioned between a front wall and a back wall of the video display device.

8. The video display device as recited in claim 1, wherein the at least one strap passes through a groove positioned on a wall of the video display device.

9. The video display device as recited in claim 1, wherein the at least one strap is a closed elastic loop.

10. The video display device as recited in claim 1, wherein the at least one strap includes two free ends capable of being fastened together to form a closed loop.

11. The video display device as recited in claim 1, wherein a length of the at least one strap is adjustable.

12. The video display device as recited in claim 1, wherein the video display device is one of a liquid crystal display device, an organic electro-luminescent display device, a cathode-ray tube device and a gas plasma device.

13. The video display device as recited in claim 1, further comprising a navigation system, wherein the video display device displays navigation information from the navigation system on the screen.

14. The video display device as recited in claim 1, wherein the video display device is coupled to a navigation system and displays navigation information from the navigation system on the screen.

15. The video display device as recited in claim 1, wherein the video display device is coupled to a media player for displaying a video program from the media player.

16. The video display device as recited in claim 15, wherein the video display device displays the video program only when the vehicle is stationary.

17. The video display device as recited in claim 15, wherein the video display device displays the video program only when a parking brake of the vehicle is engaged.

18. The video display device as recited in claim 15, further comprising a device port, wherein the media player is coupled to the video display device through the device port.

19. The video display device as recited in claim 15, wherein the media player is one of a portable media player or a media player mounted in the vehicle.

20. The video display device as recited in claim 1, further comprising a device port, wherein a navigation device is coupled to the video display device through the device port.

21. The video display device as recited in claim 1, further comprising a connector for connecting the video display device to a wiring harness of the vehicle.

22. The video display device as recited in claim 21, wherein the video display device is coupled to at least one of a vehicle navigation system, a vehicle media player, a vehicle power supply and a parking brake indicator signal via the connector and the wiring harness.

23. A video display device, comprising:
a screen, wherein:
the video display device is capable displaying vehicle navigation information and a video entertainment program on the screen; and
the video display device is capable of being mounted to a visor in a vehicle.

24. The video display device as recited in claim 23, further comprising:
at least one strap connected to the video display device, wherein the at least one strap is capable of fitting around the visor.

25. The video display device as recited in claim 23, wherein the video display device is one of a liquid crystal display device, an organic electro-luminescent display device, a cathode-ray tube device and a gas plasma device.

26. The video display device as recited in claim 23, wherein the video display device displays the video entertainment program only when the vehicle is stationary.

27. The video display device as recited in claim 23, wherein the video display device displays the video entertainment program only when a parking brake of the vehicle is engaged.

28. The video display device as recited in claim 23, wherein the video display device receives at least one of the vehicle navigation information and the video entertainment program from at least one external device electrically connected to the video display device.

29. The video display device as recited in claim 23, wherein the video display device is houseable in a support structure including at least one strap connected to the support structure and the at least one strap is capable of fitting around the visor.

30. The video display device as recited in claim 29, wherein the support structure further includes a membrane for holding the video display device in the support structure.

31. The video display device as recited in claim 30, wherein the membrane includes a hole through which a screen of the video display device is viewed.

32. A structure for supporting a video display device, comprising:
a body portion;
at least one strap connected to the body portion for mounting the structure in an interior portion of a vehicle; and
a membrane connected to the body portion for holding the video display device in the structure.

33. The structure as recited in claim 32, wherein the at least one strap is capable of fitting around a visor in the vehicle for mounting the structure to the visor.

34. The structure as recited in claim 32, wherein the at least one strap is capable of fitting around a portion of a seat in the vehicle for mounting the structure to the seat.

35. The structure as recited in claim 32, wherein the at least one strap passes through an interior portion of the body portion.

36. The structure as recited in claim 35, wherein the at least one strap passes through the interior portion of the body portion via at least one hole formed in the body portion.

37. The structure as recited in claim 32, wherein the at least one strap is secured to a side of the body portion.

38. The structure as recited in claim 32, wherein the at least one strap is a closed elastic loop.

39. The structure as recited in claim 32, wherein the at least one strap includes two free ends capable of being fastened together to form a closed loop.

40. The structure as recited in claim 32, wherein a length of the at least one strap is adjustable.

41. The structure as recited in claim 32, wherein the membrane surrounds a substantial portion of the display device.

42. The structure as recited in claim 32, wherein the membrane includes a flap capable of being opened to provide an opening through which the video display device is placed in the structure.

43. The structure as recited in claim 42, wherein the flap is capable of being fastened to and unfastened from the body portion.

44. The structure as recited in claim 42, wherein the flap wraps around part of the body portion.

45. The structure as recited in claim 32, wherein the membrane includes at least one hole through which a control button of the display device is accessed.

46. The structure as recited in claim 32, wherein the membrane includes at least one hole through which a port of the display device is accessed.

47. The structure as recited in claim 32, wherein the membrane includes a hole through which a screen of the video display device is viewed.

48. The structure as recited in claim 32, wherein the membrane includes a hole for exposing a speaker of the video display device.

49. The structure as recited in claim 32, wherein the membrane includes a hole for exposing at least one of an infrared transmitter and an infrared receiver of the video display device.

50. The structure as recited in claim 32, wherein the membrane is bendable.

51. The structure as recited in claim 32, wherein the membrane is transparent.

52. The structure as recited in claim 32, wherein the video display device is one of a liquid crystal display device, an organic electro-luminescent display device, a cathode-ray tube device and a gas plasma device.

53. The structure as recited in claim 32, wherein the video display device is coupled to a navigation system and displays navigation information from the navigation system on the screen.

54. The structure as recited in claim 32, wherein the video display device is coupled to a media player for displaying a video program from the media player.

55. The structure as recited in claim 54, wherein the video display device displays the video program only when a parking brake of the vehicle is engaged.
